(19) United States
(12) Patent Application Publication
(10) Pub. No.: US 2004/0258148 A1
(43) Pub. Date: Dec. 23, 2004

(54) Method and device for coding a scene

(76) Inventors: Paul Kerbiriou, Thorigne Fouillard (FR); Michel Kerdranvat, Chantepie (FR); Gwenael Kervella, Rennes (FR); Laurent Blonde, Thorigne Fouillard (FR)

Correspondence Address: Joseph S Tripoli, Thomson Licensing Inc, Patent Operations CN 5312, Princeton, NJ, 08543-0028, US

(21) Appl. No.: 10/484,891

(22) PCT Filed: Jul. 24, 2002
(86) PCT No.: PCT/FR02/02640

(30) Foreign Application Priority Data
Jul. 27, 2001 (FR) 0110086

(51) Int. Cl. H04N 7/12

(52) U.S. Cl. 375/240.01; 375/240.25

(57) ABSTRACT

The process for coding a scene composed of objects whose textures are defined on the basis of images or parts of images originating from various video sources is disclosed by spatially composing an image by dimensioning and positioning on the image, the other images or parts of images originating from various video sources, as to obtain a composed image, and, calculating and coding auxiliary data comprising information related to the composition of the composed image and information related to the textures of the objects.

The invention relates to a process and a device for coding and for decoding a scene composed of objects whose textures originate from various video sources.

More and more multimedia applications are requiring the utilization of video information at one and the same instant.

Multimedia transmission systems are generally based on the transmission of video information, either by way of separate elementary streams, or by way of a transport stream multiplexing the various elementary streams, or a combination of the two. This video information is received by a terminal or receiver consisting of a set of elementary decoders that simultaneously carry out the decoding of each of the elementary streams received or demultiplexed. The final image is composed on the basis of the decoded information. Such is for example the case for the transmission of MPEG 4 coded video data streams.

This type of advanced multimedia system attempts to offer the end user great flexibility by affording him possibilities of compostion of several streams and of interactivity at the terminal level. The extra processing is in fact fairly considerable when the complete chain is considered, from the generation of the simple streams to the restoration of a final image. It relates to all the levels of the chain: coding, addition of the inter-stream synchronization elements, packetization, multiplexing, demultiplexing, allowance for inter-stream synchronization elements and depacketization and decoding.

Instead of having a single video image, it is necessary to transmit all the elements from which the final image will be composed, each in an elementary stream. It is the composition system, on reception, that builds the final image of the scene to be depicted as a function of the information defined by the content creator. Great complexity of management at the system level or at the processing level (preparation of the context and data, presentation of the results, etc) is therefore generated.

Other systems are based on the generation of mosaics of images during post-production, that is to say before their transmission. Such is the case for example for services such as program guides. The image thus obtained is coded and transmitted, for example in the MPEG 2 standard.

The early systems therefore necessitate the management of numerous data streams at both the send level and the receive level. A local composition or ((scene ) cannot be produced in a simple manner on the basis of several videos. Expensive devices such as decoders and complex management of these decoders must be set in place for the utilization of the streams. The number of decoders may be dependent on the various types of codings utilized for the data received corresponding to each of the streams but also on the number of video objects from which the scene may be composed. The processing time for the signals received, owing to centralized management of the decoders, is not optimized. The management and processing of the images obtained, owing to their multitude, are complex.

As regards the image mosaic technique on which the other systems are based, it affords few possibilities of composition and of interaction at the terminal level and leads to excessive rigidity.

The aim of the invention is to alleviate the aforesaid drawbacks.

Its subject is a process for coding a scene composed of objects whose textures are defined on the basis of images or parts of images originating from various video sources (1₁, . . . 1ₙ), characterized in that it comprises the steps:

of spatial composition (2) of an image by dimensioning and positioning on an image, the said images or parts of images originating from the various video sources, to obtain a composed image,

of coding (3) of the composed image,

of calculation and coding of auxiliary data (4) comprising information relating to the composition of the composed image, to the textures of the objects and to the composition of the scene.

According to a particular implementation, the composed image is obtained by spatial multiplexing of the images or parts of images.

According to a particular implementation, the video sources from which the images or parts of images comprising one and the same composed image are selected, have the same coding standards. The composed image also comprises a still image not originating from a video source.

According to a particular implementation, the dimensioning is a reduction in size obtained by subsampling.

According to a particular implementation, the composed image is coded according to the MPEG 4 standard and the information relating to the composition of the image is the coordinates of textures.

The invention also relates to a process for decoding a scene composed of objects, which scene is coded on the basis of a composed video image grouping together images or parts of images of various video sources and on the basis of auxiliary data which are information regarding composition of the composed video image and information relating to the textures of the objects, characterized in that it performs the steps of:

decoding of the video image to obtain a decoded image

decoding of the auxiliary data,

extraction of textures of the decoded image on the basis of the image's composition auxiliary data,

overlaying of the textures onto objects of the scene on the basis of the auxiliary data relating to the textures.

According to a particular implementation, the extraction of the textures is performed by spatial demultiplexing of the decoded image.

According to a particular implementation, a texture is processed by oversampling and spatial interpolation to obtain the texture to be displayed in the final image depicting the scene.

The invention also relates to a device for coding a scene composed of objects whose textures are defined on the basis of images or parts of images originating from various video sources, characterized in that it comprises:

a video editing circuit receiving the various video sources so as to dimension and position on an image, images or parts of images originating from these video sources, so as to produce a composed image,

a circuit for generating auxiliary data which is linked to the video editing circuit so as to provide information relating to the composition of the composed image and to the textures of the objects,

a circuit for coding the composed image,

a circuit for coding the auxiliary data.

The invention also relates to a device for decoding a scene composed of objects, which scene is coded on the basis of a composed video image grouping together images or parts of images of various video sources and on the basis of auxiliary data which are information regarding composition of the composed video image and information relating to the textures of the objects, characterized in that it comprises:

a circuit for decoding the composed video image so as to obtain a decoded image,

a circuit for decoding the auxiliary data,

a processing circuit receiving the auxiliary data and the decoded image so as to extract textures of the decoded image on the basis of the image's composition auxiliary data and to overlay textures onto objects of the scene on the basis of the auxiliary data relating to the textures.

The idea of the invention is to group together, on one image, elements or elements of texture that are images or parts of images originating from various video sources and that are necessary for the construction of the scene to be depicted, in such a way as to “transport” this video information on a single image or a limited number of images. Spatial composition of these elements is therefore carried out and it is the global composed image obtained that is coded instead of a separate coding of each video image originating from the video sources. A global scene whose construction customarily requires several video streams may be constructed from a more limited number of video streams and even from a single video stream transmitting the composed image.

By virtue of the sending of an image composed in a simple manner and the transmission of associated data describing both this composition and the construction of the final scene, the decoding circuits are simplified and the construction of the scene carried out in a more flexible manner.

Taking a simple example, if instead of coding and separately transmitting four images in the QCIF format (the acronym standing for Quarter Common Intermediate Format), that is to say of coding and of transmitting each of the four images in the QCIF format on an elementary stream, just a single image is transmitted in the CIF (Common Intermediate Format) format grouping these four images together, the processing at the coding and decoding level is simplified and faster, for images of identical coding complexity.

On reception, the image is not simply presented. It is recomposed using transmitted composition information. This enables the user to be presented with a less frozen image, with the potential inclusion of animation resulting from the composition, and makes it possible to offer him more comprehensive interactivity, it being possible for each recomposed object to be active.

Management at the receiver level is simplified, the data to be transmitted may be further compressed owing to the grouping together of video data on one image, the number of circuits necessary for decoding is reduced. Optimization of the number of streams makes it possible to minimize the resources necessary with respect to the content transmitted.

Other features and advantages of the invention will become clearly apparent in the following description given by way of nonlimiting example and with regard to the appended figures which represent:

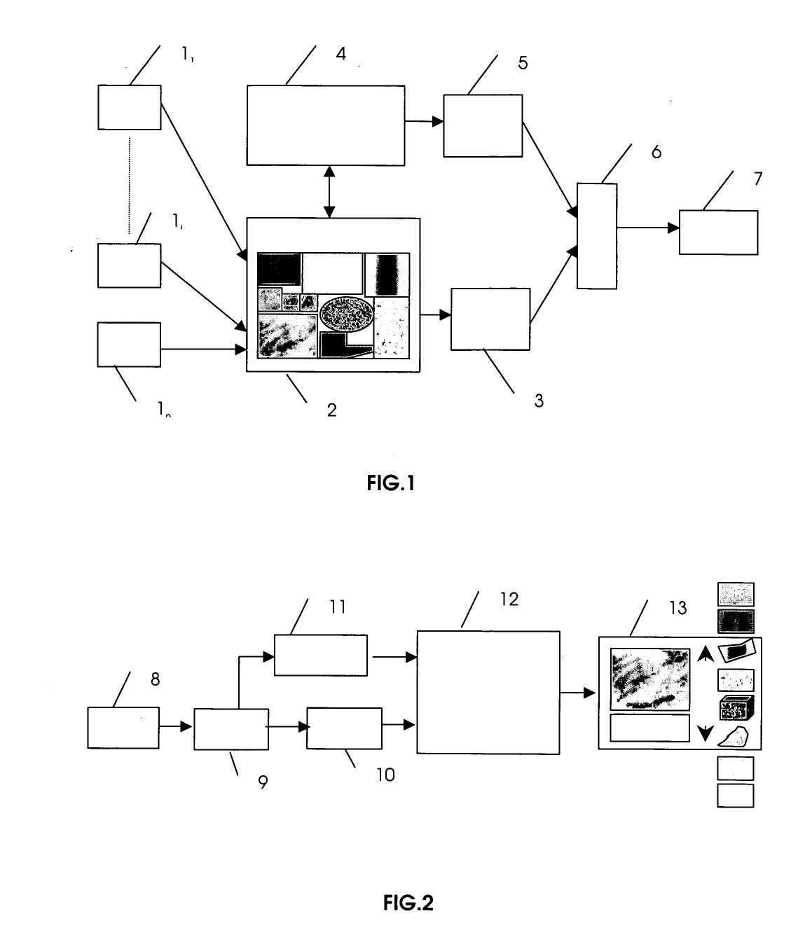

FIG. 1 a coding device according to the invention,

FIG. 2 a receiver according to the invention,

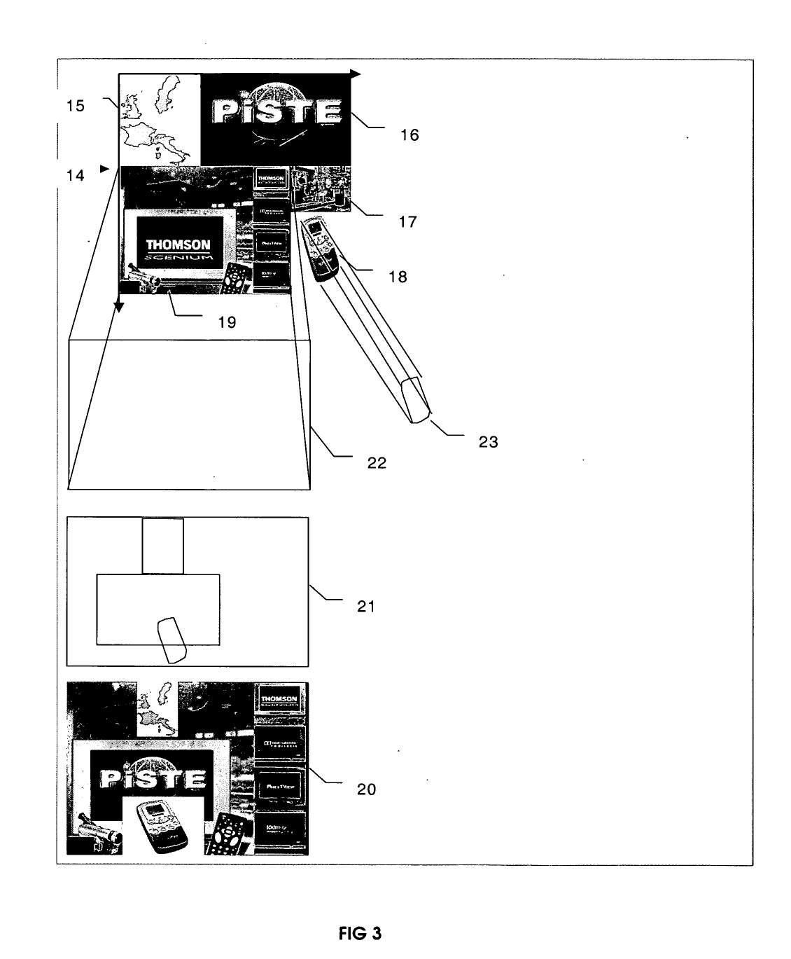

FIG. 3 an example of a composite scene.

FIG. 1 represents a coding device according to the invention. The circuits 1₁ to 1ₙ symbolize the generation of the various video signals available at the coder for the coding of a scene to be displayed by the receiver. These signals are transmitted to a composition circuit 2 whose function is to compose a global image from those corresponding to the signals received. The global image obtained is called the composed image or mosaic. This composition is defined on the basis of information exchanged with a circuit for generating auxiliary data 4. This is composition information making it possible to define the composed image and thus to extract, at the receiver, the various elements or subimages of which this image is composed, for example information regarding position and shape in the image, such as the coordinates of the vertices of rectangles if the elements constituting the transmitted image are of rectangular shape or shape descriptors. This composition information makes it possible to extract textures and it is thus possible to define a library of textures for the composition of the final scene.

These auxiliary data relate to the image composed by the circuit 2 and also to the final image representing the scene to be displayed at the receiver. It is therefore graphical information, for example relating to geometrical shapes, to forms, to the composition of the scene making it possible to configure a scene represented by the final image. This information defines the elements to be associated with the graphical objects for the overlaying of the textures. It also defines the possible interactivities making it possible to reconfigure the final image on the basis of these interactivities.

The composition of the image to be transmitted may be optimized as a function of the textures necessary for the construction of the final scene.

The composed image generated by the composition circuit 2 is transmitted to a coding circuit 3 that carries out a coding of this image. This is for example an MPEG type coding of the global image then partitioned into macroblocks. Limitations may be provided in respect of motion estimation by reducing the search windows to the dimension of the subimages or to the inside of the zones in which the elements of one image to the next are positioned, doing so in order to compel the motion vectors to point to the same subimage or coding zone of the element. The auxiliary data originating from the circuit 4 are transmitted to a coding circuit 5 that carries out a coding of these data. The outputs of the coding circuits 3 and 5 are transmitted to the inputs of a multiplexing circuit 6 which performs a multiplexing of the data received, that is to say of the video data relating to the composed image and auxiliary data. The output of the multiplexing circuit is transmitted to the input of a transmission circuit 7 for transmission of the multiplexed data.

The composed image is produced from images or from image parts of any shapes extracted from video sources but may also contain still images or, in a general manner, any type of representation. Depending on the number of subimages to be transmitted, one or more composed images may be produced for one and the same instant, that is to say for a final image of the scene. In the case where the video signals utilize different standards, these signals may be grouped together by standard of the same type for the composition of a composed image. For example, a first composition is carried out on the basis of all the elements to be coded according to the MPEG-2 standard, a second composition on the basis of all the elements to be coded according to the MPEG-4 standard, another on the basis of the elements to be coded according to the JPEG or GIF images standard or the like, so that a single stream per type of coding and/or per type of medium is sent.

The composed image may be a regular mosaic consisting for example of rectangles or subimages of like size or else an irregular mosaic. The auxiliary stream transmits the data corresponding to the composition of the mosaic.

The composition circuit can perform the composition of the global image on the basis of encompassing rectangles or limiting windows defining the elements. Thus a choice of the elements necessary for the final scene is made by the compositor. These elements are extracted from compositor available images originating from various video streams. A spatial composition is then carried out on the basis of the elements selected by “placing” them on a global image constituting a single video. The information relating to the positioning of these various elements, coordinates, dimensions, etc, is transmitted to the circuit for generating auxiliary data which processes them so as to transmit them on the stream.

The composition circuit is conventional. It is for example a professional video editing tool, of the “Adobe première” type (Adobe is a registered trademark). By virtue of such a circuit, objects can be extracted from the video sources, for example by selecting parts of images, the images of these objects may be redimensioned and positioned on a global image. Spatial multiplexing is for example performed to obtain the composed image.

The scene construction means from which part of the auxiliary data is generated are also conventional. For example, the MPEG4 standard calls upon the VRML (Virtual Reality Modelling Language) language or more precisely the BIFS (Binary Format for Scenes) binary language that makes it possible to define the presentation of a scene, to change it, to update it. The BIFS description of a scene makes it possible to modify the properties of the objects and to define their conditional behaviour. It follows a hierarchical structure which is a tree-like description.

The data necessary for the description of a scene relate, among other things, to the rules of construction, the rules of animation for an object, the rules of interactivity for another object, etc. They describe the final scenario. Part or all of this data constitutes the auxiliary data for the construction of the scene.

FIG. 2 represents a receiver for such a coded data stream. The signal received at the input of the receiver 8 is transmitted to a demultiplexer 9 which separates the video stream from the auxiliary data. The video stream is transmitted to a video decoding circuit 10 which decodes the global image such as it was composed at the coder level. The auxiliary data output by the demultiplexer 9 are transmitted to a decoding circuit 11 that carries out a decoding of the auxiliary data. Finally a processing circuit 12 processes the video data and the auxiliary data originating from the circuits 10 and 11 respectively so as to extract the elements, the textures necessary for the scene, then to construct this scene, the image representing the latter then being transmitted to the display 13. Either the elements constituting the composed image are systematically extracted from the image so as to be utilized or otherwise, or the construction information for the final scene designates the elements necessary for the construction of this final scene, the recomposition information then extracting these elements alone from the composed image.

The elements are extracted, for example, by spatial demultiplexing. They are redimensioned, if necessary, by oversampling and spatial interpolation.

The construction information therefore makes it possible to select just a part of the elements constituting the composed image. This information also makes it possible to permit the user to “navigate” around the scene constructed so as to depict objects of interest to him. The navigation information originating from the user is for example transmitted as an input (not represented in the figure) to the circuit 12 which modifies the composition of the scene accordingly.

Quite obviously, the textures transported by the composed image might not be utilized directly in the scene. They might, for example, be stored by the receiver for delayed utilization or for the compiling of a library used for the construction of the scene.

An application of the invention relates to the transmission of video data in the MPEG 4 standard corresponding to several programs on the basis of a single video stream or more generally the optimization of the number of streams in an MPEG4 configuration, for example for a program guide application. If, in a traditional MPEG-4 configuration, it is necessary to transmit as many streams as videos that can be displayed at the terminal level, the process described makes it possible to send a global image containing several videos and to use the texture coordinates to construct a new scene on arrival.

FIG. 3 represents an exemplary composite scene constructed from elements of a composed image. The global image 14, also called composite texture, is composed of several subimages or elements or subtextures 15, 16, 17, 18, 19. The image 20, at the bottom of the figure, corresponds to the scene to be displayed. The positioning of the objects for constructing this scene corresponds to the graphical image 21 which represents the graphical objects.

In the case of MPEG-4 coding and according to the prior art, each video or still image corresponding to the elements 15 to 19 is transmitted in a video stream or still image stream. The graphical data are transmitted in the graphical stream.

In our invention, a global image is composed from images relating to the various videos or still images to form the composed image 14 represented at the top of the figure. This global image is coded. Auxiliary data relating to the composition of the global image and defining the geometrical shapes (only two shapes 22 and 23 are represented in the figure) are transmitted in parallel making it possible to separate the elements. The texture co-ordinates at the vertices, when these fields are utilized, make it possible to texture these shapes on the basis of the composed image. Auxiliary data relating to the construction of the scene and defining the graphical image 21 are transmitted.

In the case of MPEG-4 coding of the composed image and according to the invention, the composite texture image is transmitted on the video stream. The elements are coded as video objects and their geometrical shapes 22, 23 and texture coordinates at the vertices (in the composed image or the composite texture) are transmitted on the graphical stream. The texture coordinates are the composition information for the composed image.

The stream which is transmitted may be coded in the MPEG-2 standard and in this case it is possible to utilize the functionalities of the circuits of existing platforms incorporating receivers.

In the case of a platform that can decode more than one MPEG-2 program at a given instant, elements supplementing the main programs may be transmitted on an MPEG-2 or MPEG-4 ancillary video stream. This stream can contain several visual elements such as logos, advertizing banners, animated or otherwise, that can be recombined with one or other of the programs transmitted, at the transmitter's choice. These elements may also be displayed as a function of the user's preferences or profile. An associated interaction may be provided. Two decoding circuits are utilized, one for the program, one for the composed image and the auxiliary data. Spatial multiplexing is then possible of the program being transmitted with additional information originating from the composed image.

A single ancillary video stream may be used for a program bouquet, to supplement several programs or several user profiles.

What is claimed is:

1. Process for coding a scene composed of objects whose textures are defined on the basis of images or parts of images originating from various video sources comprising the steps:
spatially composing of an image by dimensioning and positioning on the image, all the images or parts of images originating from the various video sources, to obtain a composed image,
coding of the composed image,
calculating and coding of auxiliary data comprising information relating to the composition of the composed image, to the textures of the objects and to the composition of the scene.

2. Proses according to claim 1, wherein the composed image is obtained by spatial multiplexing of the images or parts of images.

3. Process according to claim 1, wherein the various video sources from which the images or parts of images comprising one and the same composed image are selected, correspond to the same coding standards.

4. Process according to claim 1, wherein the composed image also comprises a still image not originating from a said video source from said various video sources.

5. Process according to claim 1, wherein the step of dimensioning is a reduction in size obtained by subsampling.

6. Process according to claim 1, wherein the composed image is coded according to the MPEG 4 standard and the information relating to the composition of the image is the coordinates of textures.

7. Process for decoding a scene composed of objects, in which scene is coded on the basis of a composed video image grouping together images or parts of images of various video sources and on the basis of auxiliary data which are information regarding composition of the composed video image, information relating to the textures of the objects and to the composition of the scene, comprising the steps of:
decoding the video image to obtain a decoded image
decoding of the auxiliary data,
extraction of extracting textures of the decoded image on the basis of image composition auxiliary data,
overlaying of the textures onto objects of the scene on the basis of the auxiliary data relating to the textures and to the composition of the scene.

8. Decoding process according to claim 7, wherein the extraction of the textures is performed by spatial demultiplexing of the decoded image.

9. Decoding process according to claim 7, wherein a texture is processed by oversampling and spatial interpolation to obtain the texture to be displayed in the final image depicting the scene.

10. Device for coding a scene composed of objects whose textures are defined on the basis of images or parts of images originating from various video sources comprising:
a video editing circuit receiving the various video sources so as to dimension and position on an image, images or parts of images originating from these video sources, so as to produce a composed image,
a circuit for generating auxiliary data that is linked to the video editing circuit to provide information relating to the composition of the composed image, to the textures of the objects and to the composition of the scene,
a circuit for coding the composed image, and
a circuit for coding the auxiliary data.

11. Device for decoding a scene composed of objects, in which the scene is coded on the basis of a composed video image grouping together images or parts of images of various video sources and on the basis of auxiliary data which are information regarding composition of the composed video image and information relating to the textures of the objects and to the composition of the scene, comprising:
a circuit for decoding the composed video image so as to obtain a decoded image,
a circuit for decoding the auxiliary data, and
a processing circuit (2 for receiving the auxiliary data and the decoded image so as to extract textures of the decoded image on the basis of the image composition auxiliary data and to overlay textures onto objects of the scene on the basis of the auxiliary data corresponding to the textures and to the composition of the scene.
